(19) United States
(12) Patent Application Publication
(10) Pub. No.: US 2013/0204747 A1
(43) Pub. Date: Aug. 8, 2013

(54) TRANSACTION GENERATION METHOD AND DEVICE

(71) Applicant: Alibaba Group Holding Limited, George Town (KY)

(72) Inventor: Wei Zhao, Hangzhou (CN)

(73) Assignee: ALIBABA GROUP HOLDING LIMITED, George Town (KY)

(21) Appl. No.: 13/759,879

(22) Filed: Feb. 5, 2013

(30) Foreign Application Priority Data
Feb. 7, 2012 (CN) 201210026704.7

(51) Int. Cl. G06Q 30/06

(52) U.S. Cl. CPC G06Q 30/0627
USPC 705/26.63

(57) ABSTRACT

Embodiments of the present application relate to a transaction generation method, a transaction generation device, and a computer program product for generating a transaction. A transaction generation method is provided. The method includes receiving an unnegotiated request including preset product criteria information, generating a transaction preorder corresponding to the unnegotiated request, generating a reverse negotiation identifier, receiving an expected transaction request, searching for product characteristic information, searching for a preset product criteria information, comparing the searched product characteristic information and the preset product criteria information, and in the event that the searched product characteristic information and the preset product criteria information match, marking a supplier counterparty as a selected counterparty.

### CROSS REFERENCE TO OTHER APPLICATIONS

This application claims priority to People's Republic of China Patent Application No. 201210026704.7 entitled INTERNET NEGOTIATED TRANSACTION GENERATION METHOD AND SERVER, filed Feb. 7, 2012 which is incorporated herein by reference for all purposes.

### BACKGROUND OF THE INVENTION

As Internet technology has developed, an increasing number of e-commerce websites have appeared, and a great number of products have become available on these websites. The e-commerce websites have become one of the first shopping choices for consumers. E-commerce websites such as Amazon.com, Taobao.com, and 360buy.com all allow authorized users to directly select products that they would like to purchase, generate orders directly on a website's selling page or selling pages provided to users by the website, and complete transactions when the products are received.

The prices of products offered by the existing e-commerce websites are offered by the seller. Buyers can compare the prices of the products and characteristics of a plurality of similar products and select the product having a better value for purchase by selecting the product that they would like to purchase on the webpage to initiate a purchase request. Upon the initiation of the purchase request, an order is generated, and the transaction is completed based on the order. However, the buyers lack the capability to negotiate when purchasing products.

Some Internet group purchase websites offer consumers limited quantities of products or services at below market prices based on agreements executed between the operators of the websites and suppliers. On a webpage of an Internet group purchase website, by activating a group purchase invitation interface, users can initiate a participation request to generate a group purchase order. In the event that a set of predefined group purchase conditions are satisfied, for example, after a certain amount of time has elapsed, the website closes the group purchase invitation, and proceeds with the transaction based on the generated group purchase order.

However, because product characteristics such as product quantities and contents are provided by a group purchasing agent, the consumers passive accept the product characteristics and have little control over some of the product characteristics. In many cases, the product characteristics of such transactions may not meet the expectations of the consumers.

### BRIEF DESCRIPTION OF THE DRAWINGS

Various embodiments of the invention are disclosed in the following detailed description and the accompanying drawings.

FIG. 1 is a diagram illustrating an embodiment of a transaction generation system.

FIGS. 2A and 2B are flowcharts illustrating an embodiment of a transaction generation process.

FIG. 3 is a diagram illustrating an embodiment of a transaction generation device.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

The following specification discloses a transaction generation method and device. Preorders are generated via a user's initiation of an unnegotiated request, and a plurality of merchants select the unnegotiated request to initiate one or more expected transaction requests. A final transaction counterparty merchant is selected based on a set of conditions for a negotiated transaction, and a formal transaction order is generated. Thus, consumers can proactively join together to initiate an unnegotiated request reflecting their shopping desires, and suppliers can receive the unnegotiated request to trigger the conversion of preorders into transaction orders and complete transactions.

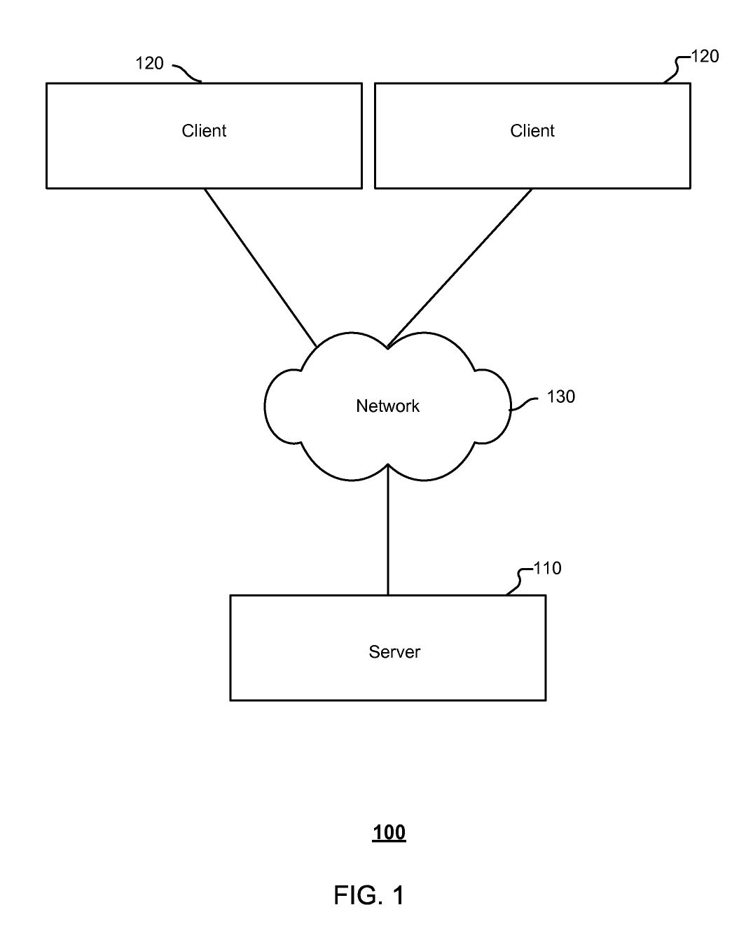

FIG. 1 is a diagram illustrating an embodiment of a transaction generation system. The system 100 includes a plurality of clients 120 connected to a server 110 via a network 130.

The server 110 is configured to receive an unnegotiated request from a potential buyer via a client 120 via the network 130, generate a transaction preorder corresponding to the unnegotiated request, and generate a reverse negotiation identifier uniquely marking the transaction preorder. The unnegotiated request includes preset product criteria information specified by the potential buyer. The server 110 can store the unnegotiated request in a database.

The server 110 is configured to receive an expected transaction request corresponding to the unnegotiated request. A potential seller can send the expected transaction request corresponding to the unnegotiated request from the client 120. The expected transaction request includes the reverse negotiation identifier and a product identifier. The server 110 can store the expected transaction request in the database.

The server 110 is configured to also search the database for product characteristic information based on the product identifier, search for a preset product criteria information included in the unnegotiated request of the transaction preorder marked with the reverse negotiation identifier, and compare the searched product characteristic information and the preset product criteria information. The server 110 is configured to return one or more unnegotiated requests having the preset product criteria information matching the product identifier of one or more expected transaction requests.

In the event that the found product characteristic information and the preset product criteria information match, the server 110 is configured to identify a supplier counterparty or potential seller which provided the expected transaction request as a selected counterparty. The supplier counterparty could potentially supply the products desired by the buyer.

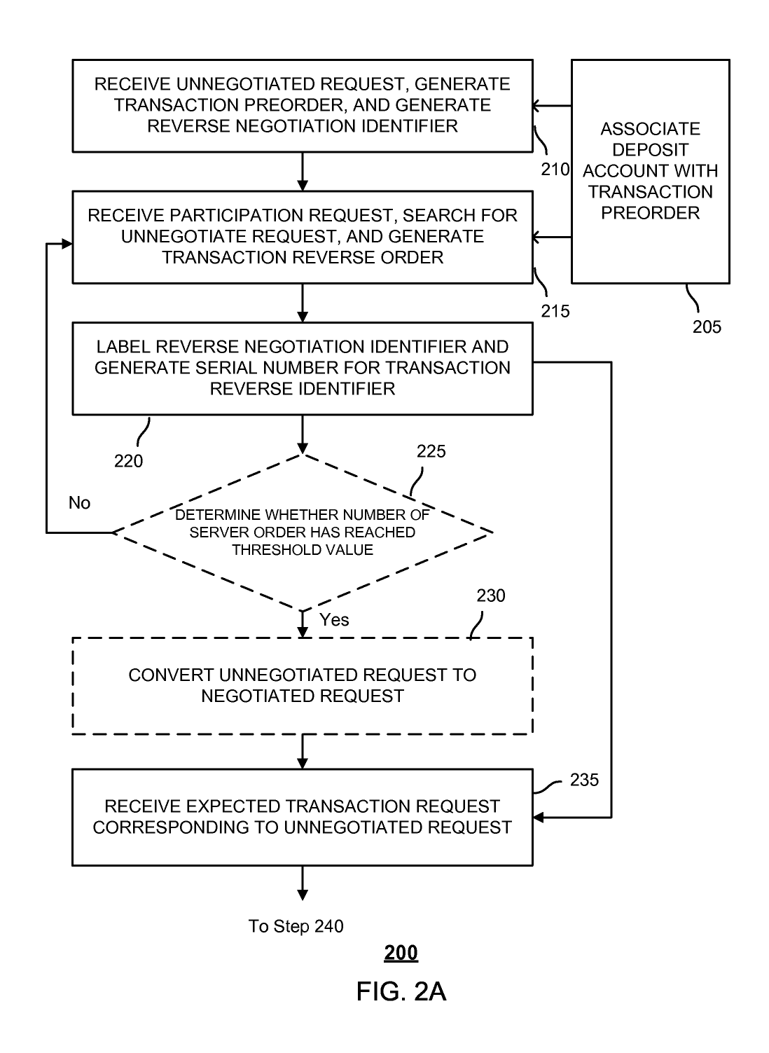

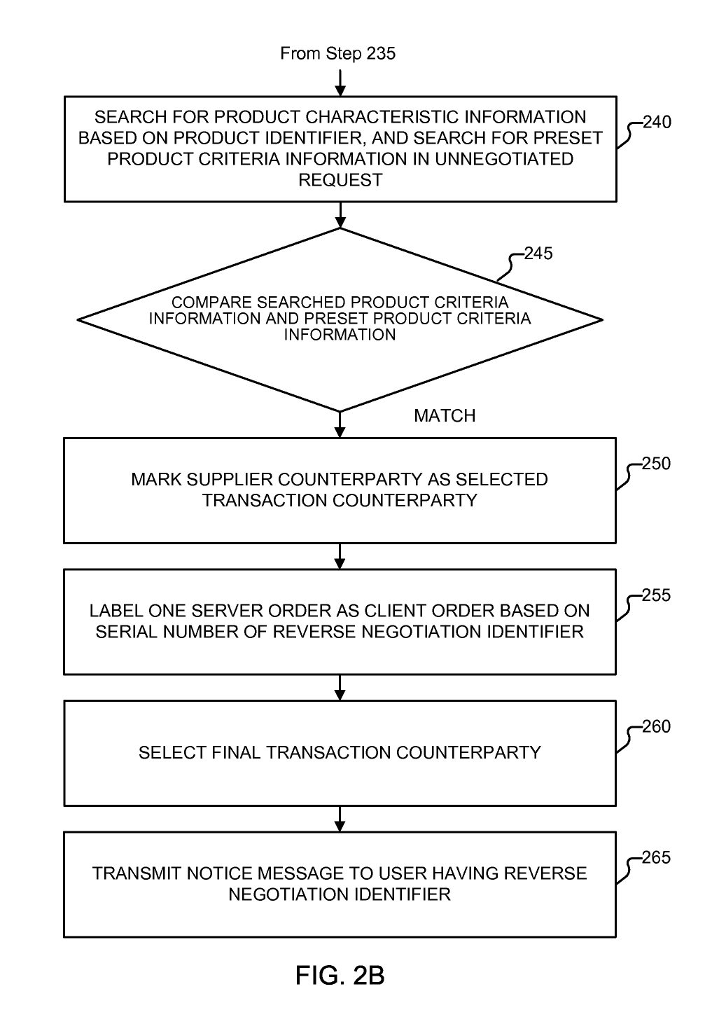

A transaction generation method of the present application is introduced below. FIGS. 2A and 2B are flowcharts illustrating an embodiment of a transaction generation process. Process 200 can be implemented on, for example, system 100. For example, assume that a user wants to purchase a refrigerator. The method 200 is described using an online shopping transaction platform server of a shopping website or a main server of a network community. The network community can be an internet system in which users publish content created by themselves, exchange information with other users, and store personal information, such as a bulletin board system (BBS) forum, an instant messaging system, a blog, a microblog, etc. The network community can also include basic information publishing systems and authority controls. An online transaction platform may be an online transaction system configured to perform order generation, transaction recording, account management and secure transactions.

As used herein, reverse negotiations refers to pricing actions initiated by buyers or third parties other than a seller. In the examples below, a reverse negotiation in which a user initiating an unnegotiated request is discussed indetail.

In the examples presented below, examples relating to a transaction platform server as the executing subject are presented; however, other servers can perform functions of the executing subject. The transaction generation method 200 comprises:

In step 210, the transaction platform server is configured to receive an unnegotiated request that includes preset product criteria information, generate a transaction preorder corresponding to the unnegotiated request as a main order or a client order, and generate a reverse negotiation identifier used to mark the uniqueness of the transaction preorder.

It should be understood that the unnegotiated request received can include preset product criteria information of at least one product to be reverse negotiated and unnegotiated transaction information. For example, the preset product criteria information for a refrigerator can include a specific name and specifications, such as side-by-side refrigerators, belonging to the category of household products and the unnegotiated transaction information can include the maximum price, deposit amount, and product quantity. The unnegotiated request may be submitted by a user having an online transaction account via a webpage of the online transaction platform server (such as a webpage displaying a list of unnegotiated requests that have been submitted by users of the online transaction platform). For example, User A having an online transaction account on website B can initiate an unnegotiated request using the online transaction account by logging into website B.

In some embodiments, after the online transaction platform server receives the unnegotiated request that includes the preset product criteria information and the unnegotiated transaction information, the online transaction platform server correspondingly saves a data record of the unnegotiated transaction information. The data record can include the unnegotiated transaction information, the preset product criteria information, current status of the transaction, current number of participants and online transaction account information of the participants. The online transaction platform server can generate the transaction preorder corresponding to the unnegotiated request and label the transaction preorder as a main order or a client order, generate the reverse negotiation identifier to mark the uniqueness of the transaction preorder, and correspondingly record the main order and reverse negotiation identifier using the online transaction account (or an identifier associated with the online transaction account).

At the same time, other unnegotiated requests published by network communities or online transaction platforms can be made available to users having the corresponding authorization levels to browse product details or participate in transactions. For example, when a user initiates an unnegotiated request, preset product criteria information of a product, e.g., a refrigerator, included in the unnegotiated request can be displayed on the current webpage. For example, the preset product criteria information can include a side-by-side refrigerator, Haier brand, and an environmentally-friendly label, and the unnegotiated transaction information can include a maximum price of 4000 dollars, deposit not to exceed 500 dollars, and a request for 2 refrigerators. An invitation to other users who want to participate in the unnegotiated request can be displayed on the current webpage. The invitation can be in the form of a button or link that other users may click to view details of the unnegotiated request. The current webpage can be a webpage displaying the terms of the unnegotiated request on the online transaction platform or the network community.

The unnegotiated request published by the user on a webpage provided by the online transaction platform or the network community can be labeled with an unnegotiated transaction tag. By using the unnegotiated transaction tag, other authorized users who want the product may initiate a participation request to participate in the reverse negotiation.

It is understood that after the user has submitted the unnegotiated request, direct negotiation or joint negotiation is possible.

Direct negotiation means that after the unnegotiated request has been transmitted by the user and published on the webpage provided by the online transaction platform or the network community, an expected transaction request is initiated by directly accessing a merchant's negotiated transaction. Except for the publisher of the webpage, users in the network community who already have an online transaction account authorization, based on the existing authority level settings of the users, can view the details of the transaction and participate in the unnegotiated request. In other words, the users can initiate participation requests without any restrictive conditions. In some embodiments, the unnegotiated request can have a validity period where a participation request is invalid after a predefined validity period.

Joint negotiation means that after a user has transmitted an unnegotiated request and after the unnegotiated request has been displayed on the webpage of the online transaction platform or the network community, community users, except for the publisher of the webpage, who already have online transaction account authorization, based on the existing authority level settings of the users, can view the details of the transaction and participate in the unnegotiated request. In other words, the users can initiate participation requests. In some embodiments, under the joint negotiation method, users are required to satisfy a set of conditions before merchants engage in a negotiated transaction. A rule may be specified that the set or a subset of conditions may need to be satisfied before the unnegotiated request is converted to a negotiated transaction. For example, the set of conditions may relate to the satisfaction of condition 1, 2, 3, or n. In another example, the set of conditions may relate to the satisfaction a plurality of conditions such as simultaneous satisfaction of conditions 1 and 2, simultaneous satisfaction of conditions 2 and 3, satisfaction of condition 1 followed by satisfaction of condition 2; or satisfaction of condition 1 followed by satisfaction of conditions 2 and 3. In one, the conditions are condition 1: deadline time and condition 2: number of participants. Satisfaction of condition 1, condition 2, or a combination thereof may be required. Of course, it should be understood that it is also possible to set additional conditions, such as condition 3: credit rating of participating counterparties, etc. When the mechanism of satisfying conditions is employed, for example, by setting the requirement that condition 3 be satisfied first, requiring that the credit rating of counterparties initiating participation requests to be grade 3, followed by the satisfaction of conditions 1 and 2. For example, condition 1 corresponds to 100 participants and condition 2 corresponds to 3 days. In other words, the satisfaction of conditions 1 and 2 relates to having 100 participants within three days of initiation. In event that the conditions are satisfied, the unnegotiated request is converted to a negotiated request and published on the webpage. Subsequently, the following steps includes: in the event that the quantity of the participation requests (the quantity of group orders), the elapsed time of the unnegotiated request, or a combination thereof satisfies the conditions set by the merchants or product suppliers to engage in a negotiated transaction, the unnegotiated request is converted to a negotiated request.

In the event that the conditions are not satisfied, the unnegotiated request is terminated. In other words, the displayed content of the unnegotiated request is deleted from the webpage. For example, a published unnegotiated request includes specific conditions for negotiation, i.e., the number of participants must reach 30 within three days of publication on the webpage, otherwise the unnegotiated request is deleted from the webpage. In this example, although the reverse negotiation request is automatically canceled, transaction preorders of users who initiated unnegotiated requests and users who initiated participation requests to participate in unnegotiated requests can continue to be stored on the online transaction platform server. Therefore, the cancellation of the unnegotiated request can also include: invalidating the unnegotiated request in the event that the set of conditions for converting the transaction preorder is not satisfied. In this example, the conversion conditions for the unnegotiated request correspond to the set of conditions for converting of the unnegotiated request to the negotiated request. The negotiated request requests a supplier or a merchant of the product to supply the product and engage in a transaction. In other words, the negotiated request requests the merchant to participate in the negotiated transaction.

After the unnegotiated request satisfies the set of conditions for the merchant to engage in a negotiated transaction, the transaction is formally published on a negotiation system, such as the online transaction platform. For example, on the webpage of the online transaction platform, in the event that a certain number of people have participated in the unnegotiated request, the webpage on which information related to the unnegotiated request is currently published is converted into a webpage have a negotiated request. At this time, the published information relating to the unnegotiated request can include the maximum price, the deposit amount, the quantity purchased, the current number of participants, preset product criteria information, and an invitation to product suppliers to participate in the transaction. The preset product criteria information can include information such as side-by-side refrigerator, and Haier brand.

Some differences between the direct negotiation model and the joint negotiation model include that under the direct negotiation model, when a user initiates an unnegotiated request, the webpage on which the information related to the unnegotiated request is displayed directly invites suppliers of a product corresponding to the unnegotiated request to participate in supplying the product. In other word, the webpage receives an expected transaction request from a product supplier to participate in the negotiated transaction, while also receiving participation requests from other users. Under the joint negotiation model, after a user initiates an unnegotiated request, when a set of conditions is satisfied, the unnegotiated request is converted to a negotiated request. In other words, the webpage invites product suppliers to participate in the negotiated transaction by, for example, providing a button or link which, when clicked by a product supplier, allows the product suppliers to participate in the negotiated transaction.

In step 215, the transaction platform server is configured to receive a participation request including the reverse negotiation identifier, search the unnegotiated request based on the reverse negotiation identifier, generate a reverse transaction order corresponding to the participation request, and label the participation request as a group order or a server order.

In step 220, the transaction platform server is configured to label the reverse negotiation identifier as a reverse negotiation identifier of the group order and generate a serial number (e.g., an alphanumerical string) for the reverse negotiation identifier of the group order. The serial number indicates the uniqueness of the group order.

It is understood that participation requests are requests for participation in the transaction initiated by other users having the corresponding authority level after browsing the product. A participation request can have the reverse negotiation identifier of the currently browsed product. For example, if user B sees a reverse negotiation list published on a webpage of an online transaction platform server, and selects the unnegotiated transaction information for the product “refrigerator” from the reverse negotiation list, user B can participate in the reverse negotiation by, for example, clicking on a “participate” button on the webpage. After receiving the participation request, the online transaction platform server searches one or more stored negotiated requests based on the reverse negotiation identifier, generates a transaction preorder for user B, and records the online transaction account of user B, the group order, the reverse negotiation identifier, and the serial number.

In summary, with respect to an initiated reverse negotiation, the online transaction platform server can use the initiating user's online transaction account to generate the transaction preorder and the unique reverse negotiation identifier, and label the transaction preorder as a main order. In the event that other users access the transaction platform server to participate in a particular reverse negotiation, the transaction platform server uses the reverse negotiation identifier to locate the relevant negotiation information of the main order, and uses a user's online transaction account to generate a new transaction preorder. As the new transaction preorder is being generated, the new transaction preorder receives the same reverse negotiation identifier as the transaction preorder. Based on the generated sequence of transaction preorders, the transaction platform server obtains unique serial numbers included in group orders having the same reverse negotiation identifier.

As described above, after an unnegotiated request is published, in the event a user participates in the negotiated transaction using the joint negotiation model, the transaction platform server is configured to determine whether the conditions for the published unnegotiated request, such as time restrictions, the quantity of group orders generated by participation requests from other users, or a combination thereof, have been satisfied, to determine whether to retain or close the group order generation portal. As illustrated in steps 225 and 230 of FIG. 2A, the transaction generation method 200 can include:

In step 225, in some embodiments, the transaction platform server is configured to determine whether the number of the group orders (the quantity of participation requests) has reached a preset threshold value, or in some embodiments, the transaction platform server is configured to determine whether the time elapsed since the publication of the unnegotiated request has reached a preset time. For example, if the time of publication of the unnegotiated transaction information is January 1, and the set time is three days, then on January 4, because the time that has elapsed is three days, participation requests initiated by users are no longer accepted, i.e., the group order generation portal is closed.

In the above examples, in addition to requiring a single condition to be satisfied, it is also possible to require multiple conditions to be satisfied, e.g., the preset cutoff time and the number of participants can be the two conditions. In other words, the server can determine whether the quantity of group orders has reached the threshold value within the cutoff time since publication of the unnegotiated request. For example, if the two conditions require the number of participants (the quantity of participation requests or group orders) to reach 100 within three days, when the two conditions are satisfied, the group order generation portal is closed. If the two conditions are not satisfied, the unnegotiated request is terminated, i.e., the displayed content of the unnegotiated request is deleted from the webpage.

It is understood that, as described above, the conditions are not limited to the examples presented above, and the determining of the set of conditions may be determining whether conditions 1, 2, 3, n or any combination thereof is satisfied. In the event that the determining of whether the set of conditions (condition 1, condition 2 and condition 3) is satisfied, the determining can include differences in time sequence, i.e., determining condition 1 first, followed by determining conditions 2 and 3, or simultaneously determining conditions 1, 2 and 3.

In step 230, in the event that the number of the group orders has reached the preset threshold value, the transaction platform server configured to refuse any participation requests initiated by users, and the unnegotiated request is converted to a negotiated request. In the event that the number of the group orders has not reached the threshold value, the transaction platform server can perform step 215.

In some embodiments, when the quantity of participation requests satisfy the threshold value, the time elapsed since the publication of the unnegotiated request, or when the conditions are otherwise met, the transaction platform server no longer accepts any participation requests initiated by users, and the unnegotiated request is converted to a negotiated request.

Steps 225 and 230 above proceed under the joint negotiation model. After step 220 is completed, steps 225 and 230 are performed, followed by the performance of step 235 in sequence. However, under the direct negotiation model, step 235 is performed directly after the performance of step 220. In other words, under the direct negotiation model, steps 225 and 230 are omitted. In the example, as described below, step 235 is executed in sequence after steps 220 and 225, but the example does not serve as a limitation. Steps 215 and 220 can also proceed substantially simultaneous with step 235 under the direct negotiation model. In another example, a button or link configured to invite other consumers or buyers wanting to participate in the unnegotiated request, and another button or link configured to invite product suppliers to supply products prompting product suppliers to initiate expected transaction requests can be displayed on the webpage. Therefore, participation requests and expected transaction requests can be initiated simultaneously or initiated in succession, and the participation requests and expected transaction requests can be performed in any sequence.

It should be noted that generated transaction preorders are order types where the user's intent is determined in advance by payment of a deposit by the user or the freezing of a corresponding amount in the user's account. In their initial state, such orders do not include a specific transaction counterparty, i.e., seller.

During the performance of steps 210 and 215, the transaction generation method 200 can further comprise:

In step 205, upon generation of a transaction preorder by receiving the unnegotiated request or the participation request, the transaction platform server is configured to associate a deposit account of the user initiating the unnegotiated request or the participation request with the transaction preorder. For example, assuming the users A and B each initiated an unnegotiated request, the deposit accounts of users A and B can be frozen corresponding to an amount.

It should be noted that if the unnegotiated request is automatically canceled based on the time elapsed or the number of participants, after automatic cancellation, the transaction platform server closes transactions for all preorders under the corresponding reverse negotiation identifier, and the transaction platform server transmits notices to the corresponding online transaction accounts and returns deposits or unfreezes the corresponding amounts.

It should also be understood that should a user submitting a main order no longer desires to participate in the transaction, the user may close their main order. As another aspect, the closing of the main order does not affect the current reverse negotiation. For example, user A decides to withdraw from the transaction, but the reverse negotiation is not closed. Therefore, the transaction platform server will label the next unclosed transaction reverse order as a main order, in sequence based on the serial numbers of the group orders.

In step 255, after the main order is deleted, the transaction platform server is configured to label as a main order, one of the group orders based on the serial numbers of the reverse negotiation identifiers. In some embodiments, the first group order is labeled as the main order. The first group order can be correspond with the earliest received unnegotiated request. Step 255 can be executed at any time throughout the negotiation process, without limitation. However, for illustrative purposes, step 255 is to be shown as being performed after step 250 in FIG. 2B.

In step 235, the transaction platform server is configured to receive an expected transaction request corresponding to the unnegotiated request. The expected transaction request can include the reverse negotiation identifier and a product identifier;

It should be understood that the expected transaction request is the unnegotiated request which a merchant can choose to willingly accept, for example, for a refrigerator, based on product information and negotiation transaction information displayed relating to the unnegotiated requests included in the reverse negotiation list published by users on the transaction platform server. For example, the expected transaction request can be initiated on the transaction platform server using, for example, an accept request button on the webpage. The expected transaction request can include the reverse negotiation identifier of the transaction request relating to the refrigerator currently being browsed, as well as the product identifier of the product that the merchant is capable of supplying. It should be further understood that the product information corresponding to the merchant's product identifier has been previously recorded on the transaction platform server. Moreover, transaction requests provided by product suppliers can first undergo a security filtering process. For example, the security filtering process can filter out spam messages that have nothing to do with the current transaction request.

Additionally, the expected transaction request provided by the merchant can also include the quoted price and the product quantity.

If the joint negotiation model is used, when the number of participation requests, the elapsed time of the unnegotiated request, or a combination thereof satisfies the conditions for merchants to engage in a negotiated transaction, the unnegotiated request is converted to a negotiated request.

The receiving of the expected transaction request corresponding to the unnegotiated request can comprise: receiving the expected transaction request corresponding to the unnegotiated request which has already been converted to the negotiated request.

As discussed above, under the direct negotiation model, step 235 is performed after step 220, and under the joint negotiation model, step 235 is performed after step 230.

In step 240, the transaction platform server is configured to search for product characteristics information based on the product identifier, and search for the preset product criteria information included in the unnegotiated request marked with the reverse negotiation identifier.

Based on the product identifier provided by the merchant, for example, the product identifier for a refrigerator, the transaction platform server is configured to search information for the product stored on the transaction platform server to find product characteristic information (side-by-side refrigerator, Haier brand) and other product information (price: 2000 RMB; number of units available: 200). Also, based on the preset product criteria information included in the unnegotiated request of the transaction reverse orders marked with the reverse negotiation identifier, for example, the product category (household appliances), the specific name and specifications (Haier, side-by-side), the maximum price (4000 RMB), the deposit amount (300 RMB), and the product quantity (30) can be found. The initial price of the product can be set by the initiator of the unnegotiated request, or product suppliers can provide price quotations or other transaction conditions, without limitation here.

In step 245, the transaction platform server is configured to compare the searched product characteristic information with the preset product criteria information.

In step 250, in the event that the preset product criteria information and the searched product characteristic information match, the transaction platform server is configured to mark the supplier counterparty who initiated the expected transaction request as a selected transaction counterparty.

It should be understood that a plurality of merchants may select unnegotiated requests that they are willing to accept, such as requests for a refrigerator. Therefore, the transaction platform server is configured to identify the merchants who conform to the product criteria information as selected transaction counterparties. For example, after specific merchant information is displayed on the current webpage, the merchant with which the transaction to be completed can be determined based on preset conditions. After product suppliers have initiated expected transaction requests, the transaction platform server can trigger the formal generation of a transaction order. Unlike in conventional servers in which transaction orders are generated randomly after consumers initiate purchase requests, or, in group purchasing, the transaction platform server generates transaction orders automatically when users participating in the group purchase have satisfied group purchase criteria. In this example, the receipt of the unnegotiated request and the transmission of the expected transaction request by a product supplier can be used to trigger the subsequent generation of transaction orders.

In some embodiments, the transaction platform server can be set to an automatic transaction mode, in which the transaction platform server selects a final transaction counterparty based on set priority criteria for reverse negotiation transactions. For example, the set priority criteria can include the first to accept the negotiation, the lowest price, merchant credit rating criteria, or any combination thereof. In some embodiments, the transaction platform server can be set to a manual transaction mode, in which the user who placed the main order or another user who made group orders selects the final transaction counterparty.

In step 260, the transaction platform server is configured to select a transaction counterparty from among the transaction counterparties to serve as the final transaction counterparty for the transaction preorder based on prioritized reverse negotiation transaction conditions or based on a selection by the main order user or the group order user.

It should be understood that after the transaction counterparties available for selection are displayed on the webpage, the transaction platform server selects the final transaction counterparty from the selected transaction counterparties based on a selection by the main order user and the group order users or based on a set of predefined conditions. For example, the selection of the final transaction counterparty can occur based on a set of prioritized reverse transaction conditions or setting the process to the manual transaction mode.

In step 265, the transaction platform server is configured to transmit a notice messages to users having reverse negotiation identifiers to confirm that a transaction order has been generated with the selected final transaction counterparty of the transaction preorder.

The transaction platform server transmits a confirmation notice to the users of the preorders having the corresponding reverse negotiation identifiers, and after receiving a confirmation from the preorder user, the preorder is converted to an ordinary order record, i.e., a transaction order is generated. An example of a follow-up action includes sending the product to the user's shipping address, and after the user confirms receipt of the product, the transaction is complete.

Therefore, the present application proactively initiates unnegotiated requests by consumer users and any other counterparties having a demand for products, such as online merchants. A detailed description of product demand information and a confirmation of the price or negotiation method are provided. The method includes inviting other users to participate using the direct negotiation or the joint negotiation method, receiving current request by interested product suppliers, providing product information for products the product suppliers are willing to provide, and selecting the product supplier willing to engage in the transaction. Consumers can join together to provide clear product demands, and generate completed orders to be triggered by the product suppliers receiving the negotiated request. Thus, the proactive purchase nature of consumers can be satisfied.

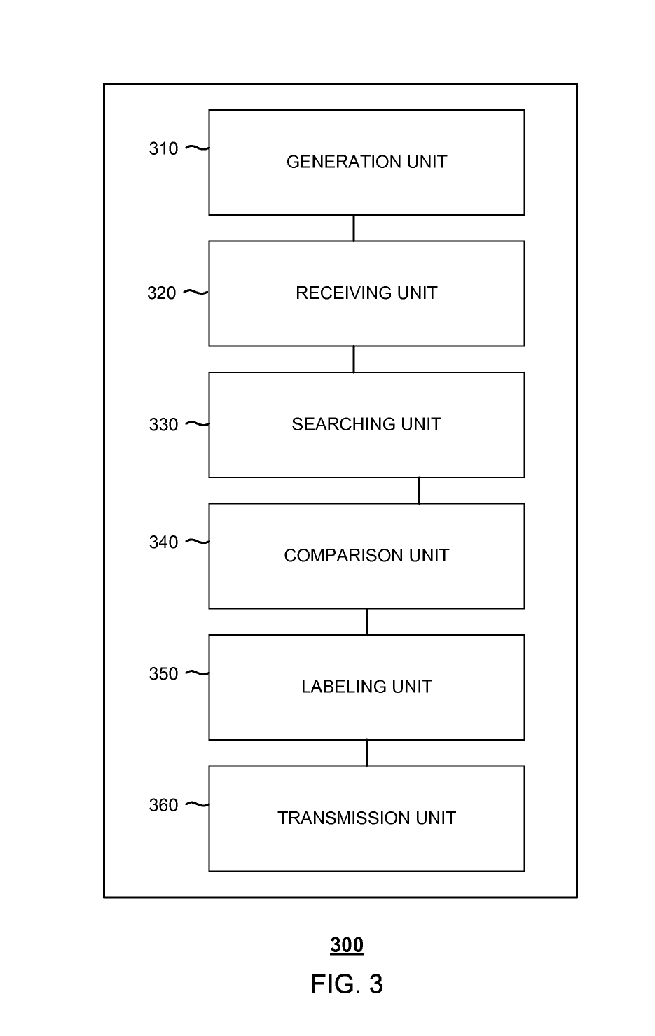

FIG. 3 is a diagram illustrating an embodiment of a transaction generation device. The device 300 comprises a generation unit 310, a receiving unit 320, a searching unit 330, a comparison unit 340, a labeling unit 350, and a transmission unit 360.

The generation unit 310 is configured to receive an unnegotiated request that includes preset product criteria information, generate a transaction preorder corresponding to the unnegotiated request, and generate a reverse negotiation identifier marking the uniqueness of the transaction preorder.

The receiving unit 320 is configured to receive an expected transaction request corresponding to the unnegotiated request. The expected transaction request can include the reverse negotiation identifier and a product identifier.

The searching unit 330 is configured to search for product characteristic information based on the product identifier, and search for the preset product criteria information included in the unnegotiated request of the transaction preorder marked with the reverse negotiation identifier.

The comparison unit 340 is configured to compare the searched product characteristic information and the preset product criteria information.

The labeling unit 350 is configured to in the event that the comparison performed by the comparison unit 340 matched, mark a supplier counterparty which provided the expected transaction request as a selected transaction counterparty.

The generation unit 310 is further configured to receive a participation request that includes the reverse negotiation identifier to search the unnegotiated request based on the reverse negotiation identifier, and generate a transaction preorder corresponding to the participation request and label the transaction preorder as a group order.

The labeling unit 350 is further configured to label the reverse negotiation identifier as the reverse negotiation identifier of the group order, and generate a serial number for the reverse negotiation identifier marking the uniqueness of the group order.

The labeling unit 350 is further configured to label the transaction preorder corresponding to the unnegotiated request as a main order.

The receiving unit 320 is further configured to select a final transaction counterparty from among the selected transaction counterparties based on a selection by a main order counterparty or a group order counterparty or based on prioritized reverse negotiation transaction conditions.

The transmission unit 360 is configured to transmit a notice message to a counterparty having the reverse negotiation identifier to confirm that a transaction order has been generated with the selected final transaction counterparty of the transaction.

The receiving unit 320 is further configured to in the event that the number of participation requests, the elapsed time of the unnegotiated request, or a combination thereof satisfies a set of conditions for a product supplier to engage in a negotiation transaction, convert the unnegotiated request to a negotiated request, and receive an expected transaction request corresponding to the unnegotiated request which has already been converted to the negotiated request.

The labeling unit 350 is further configured to after the main order has been deleted, label one group order as a main order based on serial numbers of the reverse negotiation identifiers.

The generation unit 310 is further configured to in the event that the unnegotiated request or the participation request is received, associate a deposit account of the counterparty initiating the unnegotiated request or the participation request with the transaction preorder.

Therefore, the present application proactively initiates an unnegotiated request from consumer users and any other counterparties desiring a product. The other counterparties can include online merchants. A detailed description of product demand information and a confirmation of the price or negotiation method are provided. The method invites other users to participate using the direct negotiation or the joint negotiation method, receives the current request by interested product suppliers, provides product information for the interested product suppliers who are willing to provide products, and completes the transaction by selecting the product supplier willing to engage in the transaction. Consumers can join together to provide product demands, and trigger completed orders by the suppliers receiving the negotiated request. Thus, the proactive purchase nature of consumers can be satisfied.

The units described above can be implemented as software components executing on one or more general purpose processors, as hardware such as programmable logic devices and/or Application Specific Integrated Circuits designed to perform certain functions or a combination thereof. In some embodiments, the units can be embodied by a form of software products which can be stored in a nonvolatile storage medium (such as optical disk, flash storage device, mobile hard disk, etc.), including a number of instructions for making a computer device (such as personal computers, servers, network equipment, etc.) implement the methods described in the embodiments of the present invention. The units may be implemented on a single device or distributed across multiple devices. The functions of the units may be merged into one another or further split into multiple sub-units.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A transaction generation system, comprising:
at least one processor configured to:
receive an unnegotiated request including preset product criteria information;
generate a transaction preorder corresponding to the unnegotiated request;
generate a reverse negotiation identifier that uniquely identifies the transaction preorder;
receive an expected transaction request corresponding to the unnegotiated request, the expected transaction request including the reverse negotiation identifier and a product identifier;
search for product characteristic information based on the product identifier from the received expected transaction request;
search for a preset product criteria information included in the unnegotiated request of the transaction preorder marked with the reverse negotiation identifier from the received unnegotiated request;
compare the found product characteristic information and the preset product criteria information; and
in the event that the searched product characteristic information and the preset product criteria information match, mark a supplier counterparty which provided the expected transaction request as a selected counterparty; and
a memory coupled to the at least one processor and configured to provide the at least one processor with instructions.

2. The transaction generation system as described in claim 1, wherein the at least one processor is further configured to:
receive a participation request including the reverse negotiation identifier;
search for the unnegotiated request based on the reverse negotiation identifier;
generate a transaction preorder corresponding to the participation request;
label the transaction preorder as a group order;
label the reverse negotiation identifier as a reverse negotiation identifier of the group order; and
generate a serial number for the reverse negotiation identifier of the group order.

3. The transaction generation system as described in claim 2, wherein the at least one processor is further configured to:
label the transaction preorder corresponding to the unnegotiated request as a main order; and
select a final transaction counterparty among the selected counterparty to serve as counterparty information for the main order.

4. The transaction generation system as described in claim 3, wherein the at least one processor is further configured to:
transmit a notice message to counterparties having the reverse negotiation identifier to confirm that a transaction order has been generated with the final transaction counterparty of the selected transaction preorder.

5. The transaction generation system as described in claim 2, wherein the at least one processor is further configured to:
in the event that a conversion condition of the unnegotiated request is satisfied, convert the unnegotiated request to a negotiated request,
wherein the receiving of the transaction requests corresponding to the unnegotiated request comprises:
receiving an expected transaction request in which the unnegotiated request has already been converted into the negotiated request.

6. The transaction generation system as described in claim 2, wherein the at least one processor is further configured to:
label the group order as a main order based on the serial number of the reverse negotiation identifier.

7. The transaction generation system as described in claim 2, wherein the at least one processor is further configured to:
upon the receiving of the unnegotiated request or the participation request, associate the transaction preorder and deposit account data of a counterparty of the unnegotiated request or a counterparty of the participation request.

8. The transaction generation system as described in claim 2, wherein information relating to the unnegotiated request is transmitted in accordance with a required format through an information display system of a network community, or is transmitted directly on an online purchase transaction platform using a network transaction account.

9. The transaction generation system as described in claim 7, wherein information of the unnegotiated request is labeled with an unnegotiated transaction tag, the unnegotiated transaction tag being used to initiate the participation request.

10. A transaction generation method, comprising:
receiving an unnegotiated request including preset product criteria information;
generating a transaction preorder corresponding to the unnegotiated request;
generating a reverse negotiation identifier that uniquely identifies the transaction preorder;
receiving an expected transaction request corresponding to the unnegotiated request, the expected transaction request including the reverse negotiation identifier and a product identifier;
searching for product characteristic information based on the product identifier from the received expected transaction request;
searching for a preset product criteria information included in the unnegotiated request of the transaction preorder marked with the reverse negotiation identifier from the received unnegotiated request;
comparing, using a processor, the found product characteristic information and the preset product criteria information; and
in the event that the searched product characteristic information and the preset product criteria information match, marking a supplier counterparty which provided the expected transaction request as a selected counterparty.

11. A computer program product for generating a transaction, the computer program product being embodied in a non-transitory computer readable storage medium and comprising computer instructions for:
receiving an unnegotiated request including preset product criteria information;
generating a transaction preorder corresponding to the unnegotiated request;
generating a reverse negotiation identifier that uniquely identifies the uniqueness of the transaction preorder;
receiving an expected transaction request corresponding to the unnegotiated request, the expected transaction request including the reverse negotiation identifier and a product identifier;
searching for product characteristic information based on the product identifier from the received expected transaction request;
searching for a preset product criteria information included in the unnegotiated request of the transaction preorder marked with the reverse negotiation identifier from the received unnegotiated request;
comparing the found product characteristic information and the preset product criteria information; and
in the event that the searched product characteristic information and the preset product criteria information match, marking a supplier counterparty which provided the expected transaction request as a selected counterparty.

12. The computer program product as described in claim 11, further comprising:
receiving a participation request including the reverse negotiation identifier;
searching for the unnegotiated request based on the reverse negotiation identifier;
generating a transaction preorder corresponding to the participation request;
labeling the transaction preorder as a group order;
labeling the reverse negotiation identifier as a reverse negotiation identifier of the group order; and
generating a serial number for the reverse negotiation identifier of the group order.

13. The computer program product as described in claim 12, further comprising:
labeling the transaction preorder corresponding to the unnegotiated request as a main order; and
selecting a final transaction counterparty from among the selected counterparty to serve as counterparty information for the transaction preorder.

14. The computer program product as described in claim 13, further comprising:
transmitting a notice message to counterparties having the reverse negotiation identifier to confirm that a transaction order has been generated with the final transaction counterparty of the selected transaction preorder.

15. The computer program product as described in claim 12, further comprising:
in the event that a conversion condition of the unnegotiated request is satisfied, converting the unnegotiated request to a negotiated request, to wherein the receiving of the transaction requests corresponding to the unnegotiated request comprises:
receiving an expected transaction request in which the unnegotiated request has already been converted into the negotiated request.

16. The computer program product as described in claim 12, further comprising:
labeling the group order as a main order based on the serial number of the reverse negotiation identifier.

17. The computer program product as described in claim 12, further comprising:
upon the receiving of the unnegotiated request or the participation request, associating the transaction preorder and deposit account data of a counterparty of the unnegotiated request or a counterparty of the participation request.

18. The computer program product as described in claim 12, wherein information relating to the unnegotiated request is transmitted in accordance with a required format through an information display system of a network community, or is transmitted directly on an online purchase transaction platform using a network transaction account.

19. The computer program product as described in claim 17, wherein information of the unnegotiated request is labeled with an unnegotiated transaction tag, the unnegotiated transaction tag being used to initiate the participation request.
